(19) United States
(12) Patent Application Publication
(10) Pub. No.: US 2018/0241063 A1
(43) Pub. Date: Aug. 23, 2018

(54) DURABLE FUEL ELECTRODE

(71) Applicant: Danmarks Tekniske Universitet, Kgs. Lyngby (DK)

(72) Inventors: Karen Brodersen, Kr. Hyllinge (DK); Anne Hauch, Roskilde (DK); Ming Chen, Roskilde (DK); Johan Hjelm, Malmö (SE)

(21) Appl. No.: 15/753,072

(22) PCT Filed: Aug. 18, 2016
(86) PCT No.: PCT/EP2016/069580

§ 371 Date: Feb. 15, 2018

(30) Foreign Application Priority Data
Aug. 18, 2015 (EP) 15181381.3

(51) Int. Cl. H01M 8/1253; H01M 8/0271; H01M 4/90; H01M 4/86

(52) U.S. Cl. CPC H01M 8/1253; H01M 8/0271; H01M 2008/1293; H01M 4/9066; H01M 4/8647; H01M 4/9025

(57) ABSTRACT

The present invention relates to a composite for an electrode, a composite precursor, a method of manufacturing a composite, and the composite obtained by said method. The invention further relates to an electrode comprising the composite, as well as a solid state electrochemical cell comprising the composite. The invention also relates to the use of the composite as a fuel electrode, solid oxide fuel cell, and/or solid oxide electrolyser. The invention discloses a composite for an electrode, comprising a three-dimensional network of dispersed metal particles, stabilised zirconia particles and pores, wherein the size of the pores is smaller than the size of the metal particles, wherein the size of the metal particles is essentially equal to or smaller than the size of the stabilised zirconia particles, wherein the porosity is below 33, 30, or 29 vol %, more preferably below 26 or 24 vol %, and most preferably below 23, 22, 21, 18, 15, or 13 vol %, and/or wherein the pores are essentially exclusively generated from the volume created by reducing a corresponding metal oxide to the metal particles.

### FIELD OF INVENTION

The present invention relates to a composite for an electrode, a composite precursor, a method of manufacturing a composite, and the composite obtained by said method. The invention further relates to an electrode comprising the composite, as well as a solid state electrochemical cell comprising said composite. The invention also relates to the use of the composite as a fuel electrode, solid oxide fuel cell, and/or solid oxide electrolyser.

### BACKGROUND OF INVENTION

State-of-the-art electrodes for solid state electrochemical cells, such as oxide ion conducting or proton conducting solid oxide fuel cells and electrolysis cells, have a three-dimensional porous microstructure to obtain high electrochemical reaction rates (also known as high performance). The reaction sites are locations where electrons, oxygen ions and chemical reactants and products can be transported to/from, and hence where the chemical reactions occur. Therefore, these types of porous electrodes must be comprised of materials with electronic and ionic conductivities and they must have sufficient porosity to allow diffusion of the reactants and products to and from reactions sites.

To provide the electronic, ionic and gas pathways, electrodes are typically mixed-particle composites composed of necked particles, which may be fabricated by cheap wet-ceramic techniques such as tape-casting, spraying, screen-printing and laminating, followed by sintering. One example is the composite (also known as cermet) of nickel (Ni) particles and yttria-stabilized zirconia (YSZ) particles. The Ni-YSZ composite is for instance used as fuel electrode in oxide ion conducting cells, and the Ni provides electronic pathways, the YSZ provides ionic pathways and the reaction sites are the three-phase boundaries between Ni, YSZ and the gas phase.

The Ni-YSZ type electrode has been optimized significantly in the past decade. To improve the performance of the electrode, a focus has been on reducing the particle size of the composite. However, smaller particles are known to be less stable, and the long-term stability or durability of the composite structure is an issue. The stability of the metal of the cermet (e.g. Ni) is known to be particularly low during operation of a fuel electrode. The Ni phase will migrate and sinter, resulting in growth, coarsening and agglomeration of the Ni particles, thereby causing loss of electronic pathways and decreased reaction rates.

Different approaches to minimise the structural degradation of the composite electrode, and thus improve the durability, have been described. U.S. Pat. No. 7,029,777 [1] describes a composite for a fuel electrode, where the pore size and morphology is selected to limit metal (e.g. Ni) agglomeration. It is illustrated that the agglomeration decreases with smaller and asymmetric pore size, which is mainly ascribed to steric limitations. The fuel electrode is formed within a coarser pore region of a passive support, which is exemplified to have a mean pore size of 5 μm, and the electrode is further exemplified to have a mean pore size less than 1 μm, and secondary porosity with mean pore size of approximately 50-500 nm. Performance or stability data of the described structures are not disclosed in [1].

Other approaches to reduce particle size and reduce porosity have been described. Kishimoto et al. [2] describes a wet ceramic processed Ni-YSZ composites with 25.8% porosity, and with average particle sizes of 1 μm for Ni, and 700 nm for YSZ. However, the particle size distributions were indicated to be broad, and from the electrochemical test it can be construed that the composite showed limited long-term stability.

Lay-Grindler et al. [3] describes a Ni-YSZ composite with a low porosity of 20%. However, very limited long-term stability was observed. This was seen as a doubling of the Ni particle sizes after 1000 hours of operation.

### SUMMARY OF INVENTION

The present invention provides a novel composite for an electrode, wherein the composite provides high performance and surprisingly long-term durability. This may result in a significant reduction of system cost as the lifetime of the cells is increased remarkably. In addition to these advantages, the novel composite can be manufactured using simple and cheap wet ceramic processes.

A first aspect of the invention relates to a composite for an electrode, comprising a three-dimensional network of dispersed metal particles, stabilised zirconia particles and pores, wherein the size of the pores is smaller than the size of the metal particles, and wherein the size of the metal particles is essentially equal to or smaller than the size of the stabilised zirconia particles, wherein the porosity is below 33, 30, or 29 vol %, more preferably below 26 or 24 vol %, and most preferably below 23, 22, 21, 18, 15, or 13 vol %, and/or wherein the pores are essentially exclusively generated from the volume created by reducing a corresponding metal oxide to the metal particles.

A second aspect of the invention relates to an electrode for an electrochemical cell, comprising the composite according to the first aspect of the invention.

A third aspect of the invention relates to a solid state electrochemical cell, comprising the composite according to the first aspect of the invention.

A fourth aspect of the invention relates to the use of the electrochemical cell according to the third aspect of the invention as a solid oxide fuel cell, and/or a solid oxide electrolyser.

A fifth aspect of the invention relates to a composite precursor for an electrode, comprising a three-dimensional network of dispersed particles of a metal oxide and a stabilised zirconia,

wherein the characteristic size of the particle size distribution is d₁₀ between 0.03-0.07 μm, d₅₀ between 0.08-0.4 μm, d₉₀ between 0.4-1.2 μm, more preferably d₁₀ between 0.04-0.06 μm, d₅₀ between 0.1-0.3 μm, d₉₀ between 0.9-1.1 μm, and most preferably d₁₀=0.05 μm, d₅₀=0.2 μm, and d₉₀=1 μm, and/or wherein the porosity is below 5 vol %, more preferably below 3 vol %, and most preferably below 1 vol %.

A sixth aspect of the invention relates to a method of manufacturing a composite, comprising the steps of:
(a) providing a powder of a metal oxide and a stabilised zirconia,
(b) applying ceramic processing means such as mixing and milling to the powders, sufficiently to obtain the precursor according to the fifth aspect of the invention is obtained,
(c) exposing the precursor to sintering in oxidising conditions, and
(d) exposing the sintered precursor to a thermal treatment in reducing conditions,
   whereby the metal oxide of the precursor is reduced to metallic form, and thereby forming a composite of dispersed metal particles, stabilised zirconia particles and pores.

A seventh aspect of the invention relates to the composite for an electrode according to the second aspect of the invention obtained by the the sixth aspect of the invention.

### DESCRIPTION OF DRAWINGS

The invention will in the following be described in greater detail with reference to the accompanying drawings.

FIG. 1 shows performance and durability of the two electrolysis cells with different fuel electrodes of Examples 1 and 2. Ex. 1 (shown with grey curve) comprised a standard Ni-YSZ composite, and Ex. 2 (shown with black curve) comprised an embodiment of the composite of the current invention. The degradation in cell voltage as a function of time is shown in (a), and the degradation in cell polarisation resistance (Rₚ) is shown in (b), and the degradation in cell ohmic resistance (Rₛ) is shown in (c). Measurements were carried out 800° C., −1 A/cm², H₂O/H₂:90/10 (inlet), 56% H₂O conversion, and O₂ to the oxygen electrode.

FIG. 2 shows SEM micrographs of a standard composite (Ex. 1) of an electrolysis cell. The initial microstructure is shown in (b), and the microstructure after 1000 hours testing at 800° C., −1 A/cm², H₂O/H₂:90/10 (inlet), 56% H₂O conversion, and O₂ to the oxygen electrode, is shown in (a). Arrows mark places with significant changes in the microstructure after the long-term testing.

FIG. 3 shows SEM micrographs of an embodiment of the composite of the invention (Ex. 2). The initial microstructure is shown in (b) and comprises a Ni/YSZ ratio of 40/60. The microstructure after 2000 hours testing at 800° C., −1 A/cm², H₂O/H₂:90/10 (inlet), 56% H₂O conversion, and O₂ to the oxygen electrode, is shown in (a).

FIG. 4 shows low-voltage in-lens SEM images of Ni-YSZ composites with Ni/YSZ ratio of 40/60, where the Ni particles can be discerned as the brightest phase. (a) shows the initial microstructure of an embodiment of the invention (Ex. 2), and (b) shows a standard composite (Ex. 1).

FIG. 5 shows low-voltage in-lens SEM images of Ni-YSZ composites of tested cells with Ni/YSZ ratio of 40/60, where (a) shows an embodiment of the invention (Ex. 2) after 2000 hours test, and (b) shows a standard composite (Ex. 1) after 1000 hours test.

FIG. 6 shows the initial (i.e. not tested) microstructural parameters (median radius (r₅₀) and FWHM) of the pore, YSZ, and Ni phase of a standard composite (Ex. 1), and an embodiment of the invention (Ex. 2).

FIG. 7 shows the initial microstructural parameters (calculated ratios of r₅₀ between the different phases) of a standard composite (Ex. 1), and an embodiment of the invention (Ex. 2).

FIG. 8 shows the initial microstructural parameters (characteristic diameter ranges, fractions of the different phases, percolating TPB, and YSZ/Ni interface) of the of a standard composite (Ex. 1), and an embodiment of the invention (Ex. 2).

FIG. 9 shows the precursor characteristic particle size distribution of a composite precursor of NiO-YSZ for a standard precursor (Ex. 1), and an embodiment of the invention (Ex. 2).

FIG. 10 shows a distribution of the value x with the frequency, f, and indicates how the microstructural parameter FWHM is evaluated based on a distribution.

FIG. 11 shows a scheme with volume fractions of Ni, YSZ, and porosity for composites with different Ni:YSZ ratio.

FIG. 12 shows performance and durability of the two electrolysis cells with fuel electrodes comprising a Ni/YSZ ratio of 50:50, and where the electrode microstructure is respectively a standard composite (denoted “Ni/YSZ:50/50 (Stdr.)”), and a composite according to an embodiment of the invention (denoted “Ni/YSZ:50/50 (Optimized)”). The degradation in cell voltage as a function of time is shown in (a), and the degradation in cell polarisation resistance (Rₚ) is shown in (b), and the degradation in cell ohmic resistance (Rₛ) is shown in (c). Measurements were carried out 800° C., −1 A/cm², H₂O/H₂:90/10 (inlet), 56% H₂O conversion, and O₂ to the oxygen electrode.

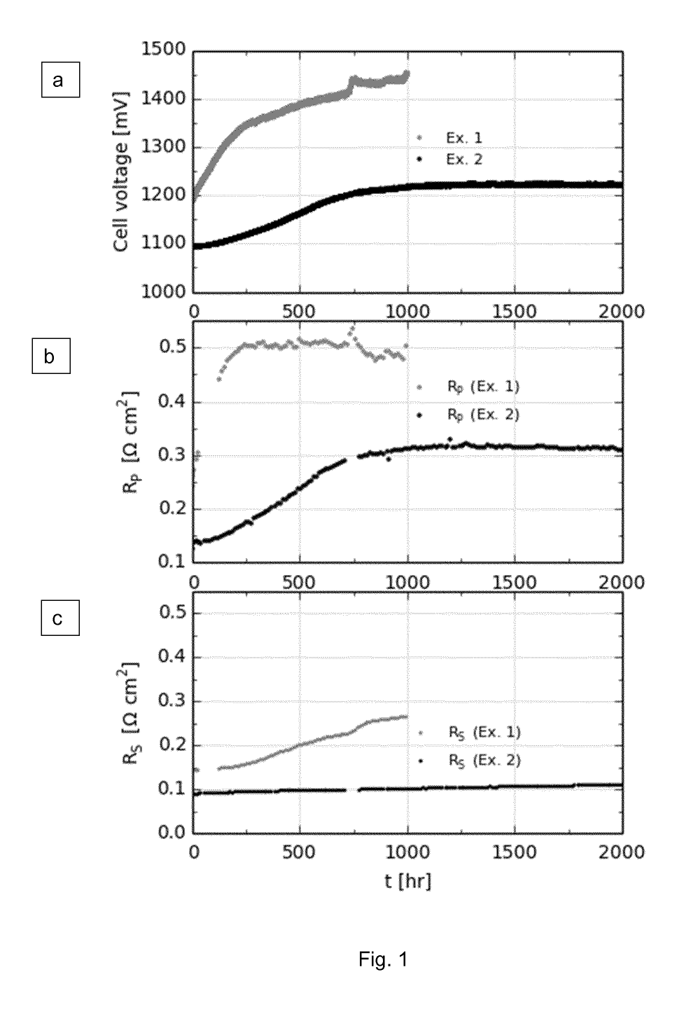

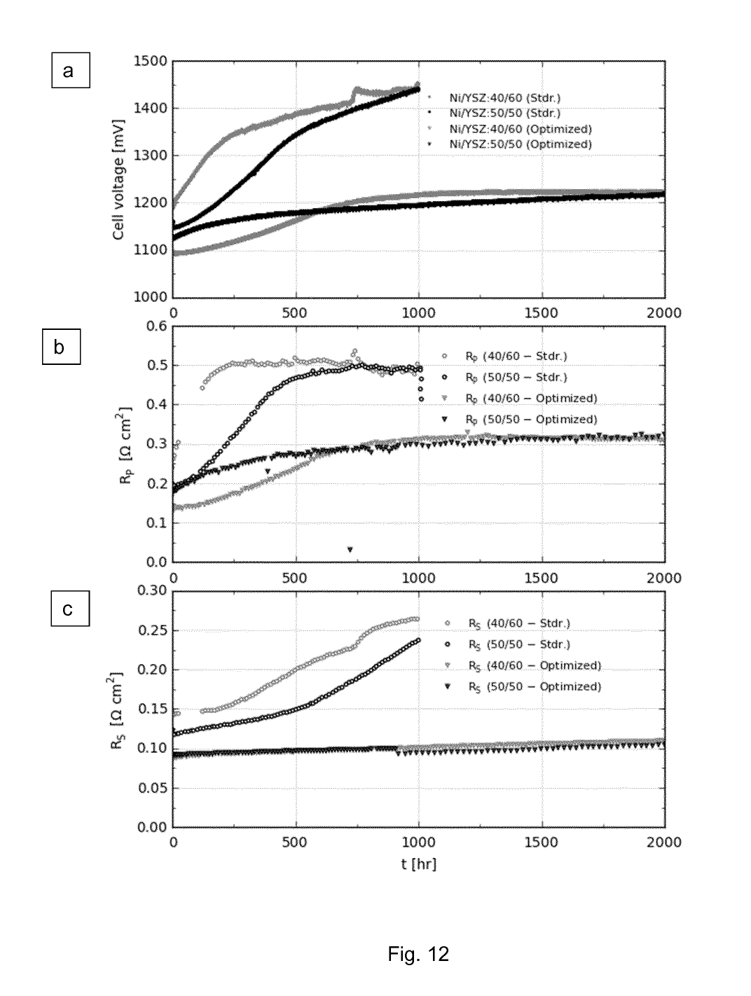

The data from FIG. 1 are included for comparison, where the data from Example 1 is denoted “Ni/YSZ:40/60 (Stdr.)” in FIG. 12, and the data from Example 2 is denoted “Ni/YSZ:40/60 (Optimized)” in FIG. 12.

### DETAILED DESCRIPTION OF THE INVENTION

The invention provides a composite for an electrode showing high performance as well as surprisingly long-term durability. The high and improved properties are related to the composite structure.

In an embodiment of the invention, the composite comprises a three-dimensional network of dispersed metal particles, stabilised zirconia particles and pores, wherein the size of the pores is smaller than the size of the metal particles, and wherein the size of the metal particles is similar or smaller than the size of the stabilised zirconia particles. In another embodiment of the invention, the composite comprises a three-dimensional network of dispersed metal particles, stabilised zirconia particles and pores, wherein the size of the pores is smaller than the size of the metal particles, wherein the size of the metal particles is essentially equal to or smaller than the size of the stabilised zirconia particles, wherein the porosity is below 33, 30, or 29 vol %, more preferably below 26 or 24 vol %, and most preferably below 23, 22, 21, 18, 15, or 13 vol %, and/or wherein the pores are essentially exclusively generated from the volume created by reducing a corresponding metal oxide to the metal particles.

By the term “similar particle size” is meant particles that have essentially equal sizes, or are about or approximately or substantially the same sizes, as would be known to the skilled person within the field.

In a further embodiment of the invention, the composite for an electrode, comprising a three-dimensional network of dispersed metal particles, stabilised zirconia particles and pores, wherein the characteristic size of the pores is smaller than the characteristic size of the metal particles, and wherein the characteristic size of the metal particles is similar or smaller than the characteristic size of the stabilised zirconia particles. In another embodiment, the characteristic size of the pores is smaller than the characteristic size of the metal particles, and wherein the characteristic size of the metal particles is essentially equal to or smaller than the characteristic size of the stabilised zirconia particles.

By the term “composite” as used herein is meant a material made of two or more materials with different physical or chemical properties, such as a composite of a ceramic material and a metallic material (also known as a cermet). An example of a composite is NiO-YSZ, and an example of a cermet is the Ni-YSZ cermet.

By the term “metal” as used herein is meant a material, compound or alloy comprising a metal element, and further showing significant electronic conductivity. Examples of metals include: nickel (Ni), copper (Cu), chromium (Cr), iron (Fe), and a combination thereof.

By the term “stabilised zirconia” as used herein is meant zirconium dioxide (ZrO₂) doped (or stabilised) with another oxide, such as yttria (Y₂O₃), scandia (Sc₂O₃), magnesia (MgO), calcia (CaO), ceria (CeO₂), or a combination thereof. Example include yttria-stabilised zirconia (Y₂O₃ doped ZrO₂, also denoted YSZ), and yttria- and scandia co-stabilised zirconia (ZrO₂ co-doped with Y₂O₃ and Sc₂O₃, also denoted ScYSZ).

The composite may also be described as the stabilised zirconia particles providing a ceramic ion-conducting phase, and dispersed in such a way to form a fine, dense, and well dispersed microstructure that hinders migration and sintering of the metallic phase e.g. Ni phase, when the composite is operated as an electrode, whereby high performance and long-term durability is obtained. In particular, high performance and long-term durability of an electrode at high current density (i.e. high fuel production rate for electrolysis cells) can be obtained. Furthermore, the composite of the invention provides a fuel electrode, which may be used in an electrolysis cell and that enables the electrolysis cell to run for several years at thermoneutral potential with fuel production rate corresponding approximately 0.45 l/h H₂ produced per cm² electrode area.

### Porosity

The stability of the composite when e.g. operated as an electrode depends on the stability of the metal phase. At elevated temperatures, a metal phase will tend to migrate and sinter, and the smaller the size of the metal phase, the stronger the tendency to migrate and sinter. If the migration and sintering of the metal phase is impeded, the composite will be more long-term durable.

The migration of a metal may be sterically inhibited by other phases, and thus by low porosity. In the current invention, the sintering of the metal phase in the composite may be inhibited by low porosity, and/or the arrangement of the pores.

The arrangement of the pores will depend on how the porosity is formed. The porosity may be obtained by reducing a corresponding oxide of a metal to the metallic form. For example, the reduction of NiO to Ni will result in pore volume due to the difference in density between NiO and Ni.

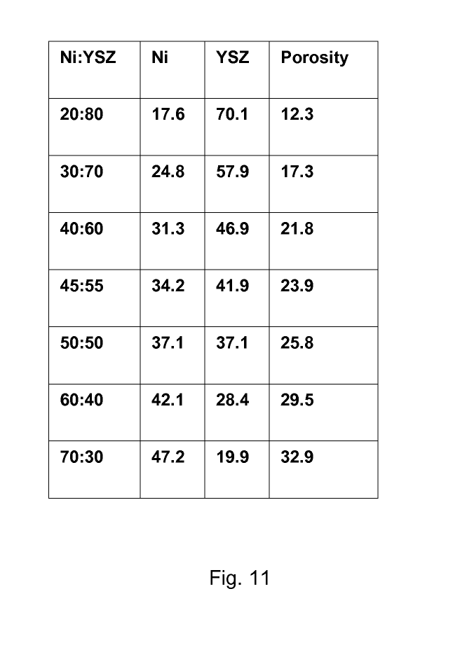

The porosity in a produced Ni-YSZ cermet may arise nearly exclusively from the volume created by reducing NiO to Ni. In a cermet with a ratio of Ni/YSZ of 50/50 this leads to a porosity of approximately 26%. In this case, the porosity may be further restricted to the vicinity of the reduced metal phase. In FIG. 11 is shown cermets with different ratios of Ni/YSZ, and the resulting volume fractions of Ni, YSZ and porosity after reduction of NiO to Ni.

In an embodiment of the invention, the porosity of the composite is generated by reducing a corresponding oxide of the metal to the metallic form. In a further embodiment, the porosity of the composite is generated exclusively from the volume created by reducing NiO to Ni.

When the porosity of the composite is generated exclusively from the volume created by reducing NiO to Ni, the pores or the porosity of the composite may be defined as essentially equal to the geometrical volume of the original NiO minus the geometrical volume of the Ni.

In a further embodiment of the invention, the porosity of the composite is essentially equal to the volume of the original NiO minus the volume of the Ni.

In a further embodiment of the invention, the generated porosity is in the vicinity of the metal phase. In a further embodiment, the porosity is below 33, 30 or 29 vol %, more preferably below 26 or 24 vol %, and most preferably below 23, 22, 21, 18, 15, or 13 vol %.

The metal of the composite should preferably have a corresponding oxide, which can be easily reduced to the metal phase, e.g. by exposure to reducing atmospheres, such as gasses comprising hydrogen. In an embodiment of the invention, the metal is selected from the group consisting of Ni, Cu, Cr, Fe, and any combination thereof. In a further embodiment, the corresponding oxide of the metal is selected from the group consisting of NiO, CuO, Cu₂O, CrO₂, Cr₂O₃, FeO, Fe₂O₃, Fe₃O₄, and any combination thereof.

### Composite

The performance and stability of a composite for an electrode comprising metal particles, stabilised zirconia particles and pores, may also depend on the composite mixture, and the chemcial composition of the stabilised zirconia.

In an embodiment of the invention, the stabilised zirconia is selected from the group consisting of yttria-stabilised zirconia, scandia-stabilised zirconia, yttria- and scandia co-stabilised zirconia, magnesia-stabilised zirconia, calcia-stabilised zirconia, ceria-stabilised zirconia, or a combination thereof.

The metal and the stabilised zirconia comprise the solid phase of the composite. Different ratios between the in the solid phase may be formed as shown in FIG. 11.

In a further embodiment, the composite comprises a metal volume fraction of the solid phase of 70, 60, 50, 45, 40, 30, or 20 vol %, most preferably essentially 30 vol %.

In a further embodiment of the invention, the volume ratio between metal and stabilised zirconia is 70:30, 60:40, 50:50, 45:55, 40:60, 30:70, or 20:80, most preferably 40:60.

### Particle and Pore Size

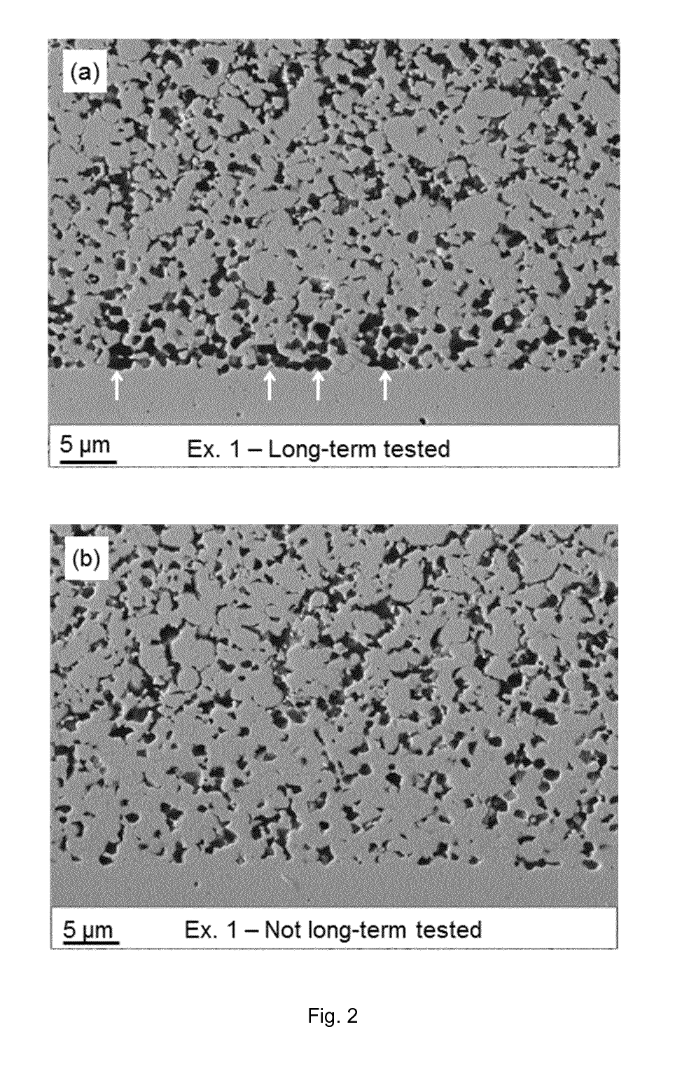

The particle size of a spherical particle is unambiguously defined by its diameter or radius. However, for most microstructures, including composites as for example shown in FIGS. 2-5, the particle shapes are not spherical and the particles may differ in sizes and have a distribution of different sizes. Thus, when applying the common techniques as known to the skilled person for evaluating particle sizes, the particle size is often quantified in terms of a representative particle diameter or radius, such as the average particle diameter. Furthermore, the size of non-spherical particles may be quantified as the diameter of an equivalent sphere, such as the sphere having the same volume as the non-spherical particle. Despite this is not a proper quantification from a geometrical point of view, it is applied to provide a quantitative description of the characteristic sizes.

In most cases, a particle size distribution exists. An example of a distribution is shown in FIG. 10 of the value x (which may be particle diameters) with the frequency, f. Apart from the distribution curve itself, a quantitative characterisation parameter of the particle sizes may include the particle size range, the average (mean) particle size, or the median particle size. Another parameter used for characterising the distribution curve is the FWHM (Full-With-Half-Max). From FIG. 10 it follows that FWHM is the difference between the two values (x₂ and x₁) at which the frequency is reduced to half of its maximum value.

In a three-dimensional (3D) network of dispersed particles, the particles may interact, and the structure may not be well described as, or consist of individual discrete particles, but rather the structure consists of continuous phase networks of varying thickness. To describe the distribution of sizes (PSD) in such a network, a 3D continuous particle size distribution is used. The continuous PSD characterizes the network by covering all parts of the network with the largest sphere that will fit inside the structure. The spheres can overlap and each part of the structure is only assigned to the largest sphere that covers it even if smaller spheres cover it as well. The continuous PSD is identical to the the conventional PSD for discrete spherical particles but extends intuitively to more complex structures. As an example the continuous PSD of a long cylinder consists of a single peak at the radius of the cylinder, since the entire volume of the cylinder can be covered by spheres the same size as the cylinder radius. The 3D continuous PSD is a computational method that works by analysing a reconstructed 3D image of a microstructure. Thus, the result of the 3D continuous PSD is the particle size distribution of the fitted spheres used to describe the network.

By the term “characteristic size” as used herein is meant the size as evaluated by 3D continuous particle size distribution. The characteristic size can be used to describe the network of the metal particle phase, the stabilised zirconia phase, and/or the pore phase. The characteristic size distribution as obtained by the 3D continuous PSD may be further described by the “average characteristic diameter”, which is the average diameter (or radius) of the size distribution of fitted spheres. The characteristic size may also be described by the “maximum characteristic diameter”, which is the diameter of the biggest fitted sphere or particle. The characteristic size may also be described by the median diameter or radius (r₅₀), which is the diameter or radius below which 50% of the particles or fitted spheres, have diameter or radius.

The 3D continuous PSD method may be used for a composite structure by combination with 3D image analyses, e.g. where the 3D image data are obtained through focused ion beam (FIB) tomography and scanning electron microscopy (SEM). Based on FIB-SEM, a 3D re-construction of the structure can be obtained, and then 3D continuous PSD is used to obtain a characteristic size distribution of the phases, such as the pores, metal, and stabilised zirconia.

The characteristic sizes of the pore phase may be the average or median (r₅₀), the maximum characteristic pore diameter, and FWHM. Similar characteristic sizes for the metal phase, and the stabilised zirconia phase can be obtained.

The performance of a composite for an electrode is dependent on the particle sizes of the composite. In general, the finer the particle size, the better the performance. However, the finer the metal particle size, the worse the stability as described earlier. The current invention provides a composite with fine particle sizes, and high stability due to the combination of particle size, in particular metal particle size, and pore microstructure and pore sizes.

In an embodiment of the invention, the maximum characteristic pore diameter is below 700 nm, more preferably below 650 nm or below 600 nm, and most preferably below 550 nm, such as 500 nm.

In a further embodiment of the invention, the median characteristic pore diameter is between 100-630 nm, more preferably between 200-500 nm, and most preferably between 300-400 nm or 350-400 nm.

In a further embodiment of the invention, the maximum characteristic metal particle diameter is below 1100 nm, more preferably below 900 nm or below 800 nm, and most preferably equal to or below 700 nm.

In a further embodiment of the invention, the median characteristic metal diameter is between 200-900 nm, more preferably between 300-800 nm or 400-700 nm, and most preferably between 500-650 nm or 550-600 nm.

### Interface Area and TPB

A three-dimensional (3D) network of dispersed particles of different phases may be described by other parameters than the characteristic size of the phases. The interface area describes the degree of contact between two phases, for example the degree of contact between the stabilised zirconia (e.g. YSZ), and the metal (e.g. Ni). The YSZ/Ni interface area may have the unit μm²/μm³, that is the interface area per electrode volume.

In a composite for an electrode, the active reaction sites are related to the interface between the phases. Thus, it is advantageous to increase the interface area per volume.

In an embodiment of the invention, the network of metal particles and stabilised zirconica particles are dispersed such that the interface area between the stabilised zirconia and metal is above 0.8 μm²/μm³, more preferably above 1 or 1.2 μm²/μm³, and most preferably equal to or above 1.4 μm²/μm³.

In a further embodiment, the network of metal particles and stabilised zirconica particles has a volume specific interface area between the stabilised zirconia and metal above 0.8 μm²/μm³, more preferably above 1 or 1.2 μm²/μm³, and most preferably equal to or above 1.4 μm²/μm³, and/or wherein the percolating TPB defined by the network of metal particles, stabilised zirconia particles and pores has a volume specific length above 1.5 μm/μm³, more preferably above 2 or 2.5 μm/μm³, and most preferably equal to or above 3.0 or 3.2 μm/μm³.

The interface area may be determined based on a 3D image analyses, such as a 3D reconstruction based on FIB/SEM. For example, to determine the YSZ/Ni interface of a composite, the YSZ/Ni interface is reconstructed as a mesh of polygons, and then taking the total sum of the area of all polygons.

In a composite for an electrode for a solid oxide cell, the active reaction sites are at the the percolating triple phase boundary (TPB). The TPBs are locations in the electrode structure at which electrons, ions and chemical reactants and products can be transported to/from, and where the electron conducting and ion conducting phase meets the pore. Thus, percolating TPB is the lines where the metal phase meets the stabilised zirconia and pore phase, and in addition where said metal phase, stabilised zirconia phase and pore phase are percolated, i.e. each phase is connected to the exterior of the composite.

From the 3D reconstruction, obtained via FIB-SEM, it is possible to determine the electrode volume specific length of the percolating triple phase boundary (TPB). The TPBs form connected curve loops inside the microstructure and are measured simply by measuring the total length of these lines from the reconstructed 3D image data. To obtain the percolating TPB length a connectivity test is made for each segment of the TPB curve to test whether the TPB segment has a percolating network pathway to the borders of the 3D reconstruction through each of the two solid phases and the pores. Only TPB curve segments that pass this test are counted in the percolating TPB length. The unit of the percolating TPB is μm/μm³; that is TPB curve length per electrode volume.

Since the active reaction sites are related to the percolating TPB, it is advantageous to increase the TPB length per volume.

In an embodiment of the invention, the network of metal particles, stabilised zirconia particles and pores are dispersed to form a percolating TPB, wherein the percolating TPB has a length above 1.5 μm/μm³, more preferably above 2 or 2.5 μm/μm³, and most preferably equal to or above 3.0 or 3.2 μm/μm³.

### Fabrication

Before reduction of the metal oxide to the corresponding the metal, the composite comprises stabilised zirconia, metal oxide, and essentially none or low porosity, as the pores are mainly formed as the metal oxide is reduced. Thus, the structure comprising the metal oxide is considered a precursor to the composite.

The precursor may be fabricated from powders of the metal oxide and the stabilised zirconia, and the precursor and composite may be formed from the powders using ceramic processing means. Typical ceramic processing means involve wet ceramic processing, where the powder are dispersed in a liquid for mixing and milling of the powders, whereby the particle size of the powders are reduced or the particle shape changed.

The precursor particle size of the powders may be measured while dispersed and/or suspended in the liquid, also known as slurry. As for the composite product, the shape of the powder particles are in most cases not spherical and a size distribution exist.

When carrying out particle sizing for slurry preparation, laser diffraction is applied. Laser diffraction measures particle size distributions by measuring the angular variation in intensity of light scattered as a laser beam passes through a dispersed particulate sample. Large particles scatter light at small angles relative to the laser beam and small particles scatter light at large angles. The angular scattering intensity data is then analyzed to calculate the size of the particles responsible for creating the scattering pattern, using the Mie theory of light scattering, which describes the interaction of light with a particle of arbitrary size. The particle size is reported as a volume equivalent sphere diameter, i.e. for a non-spherical particle, the size is ascribed as the diameter of the sphere with same volume as the particle.

The precursor particle size distribution and the precursor size may be evaluated as precursor characteristic size or diameter, where the precursor characteristic diameter means the diameter as obtained by volume equivalent sphere and/or laser diffraction means. The precursor characteristic diameters may be a size distribution, which may be described by the parameters “d₁₀”, “d₅₀”, and “d₉₀”. “d₅₀” (also written as d50) denotes the precursor characteristic particle diameter below which half (50%) of the particles have diameters below, and the other half have diameters above (i.e. it is a median value). Correspondingly, “d₁₀” and “d₉₀” denotes the precursor characteristic particle diameter below which respectively 10% and 90% of the particles have diameters below.

The parameters d₁₀, d₅₀, and d₉₀ may be obtained by laser diffraction means. For example, for a slurry of NiO and YSZ, the particle sizes of the combined NiO and YSZ may be measured by use of LS 13 320 Laser Diffraction Particle Size Analyser from Beckman Coulter. The measurement may be carried out in Ethanol with a PIDS sample loading of 45%. For Refractive index and imaginary part 2.2 and 0.1 may be used.

The particle sizes of the precursor will be reflected in the characteristic particle size distribution of the composite, and the porosity (or packing density) of the precursor (also called green body) will be reflected in the porosity of the composite.

In an embodiment of the invention, the composite precursor for an electrode, comprises a three-dimensional network of dispersed particles of a metal oxide and a stabilised zirconia, wherein the precursor characteristic particle size distribution is tri-modal, and wherein the precursor characteristic size is d₁₀ between 0.03-0.07 μm, d₅₀ between 0.08-0.4 μm, d₉₀ between 0.4-1.2 μm, more preferably d₁₀ between 0.04-0.06 μm, d₅₀ between 0.1-0.3 μm, d₉₀ between 0.9-1.1 μm, and most preferably d₁₀=0.05 μm, d₅₀=0.2 μm, and d₉₀=1 μm.

In a further embodiment of the invention, the porosity of the composite precursor is below 5 vol %, more preferably below 3 vol %, and most preferably below 1 vol %.

In another embodiment of the invention, the composite is obtained by a method of manufacturing a composite for an electrode, comprising the steps of:
(a) providing a powder of a metal oxide and a stabilised zirconia,
(b) applying ceramic processing means such as mixing and milling to the powders,
   whereby the precursor according to any of the previous embodiments is obtained,
(c) exposing the precursor to sintering in oxidising conditions, and
(d) exposing the sintered precursor to a thermal treatment in reducing conditions,
   whereby the metal oxide of the precursor is reduced to metallic form, and thereby forming a composite of dispersed metal particles, stabilised zirconia particles and pores.

In another embodiment of the invention, a method of manufacturing a composite is provided, comprising the steps of:
(a) providing a powder of a metal oxide and a stabilised zirconia,
(b) applying ceramic processing means such as mixing and milling to the powders, sufficiently to obtain the precursor described above,
(c) exposing the precursor to sintering in oxidising conditions, and
(d) exposing the sintered precursor to a thermal treatment in reducing conditions,
   whereby the metal oxide of the precursor is reduced to metallic form, and thereby forming a composite of dispersed metal particles, stabilised zirconia particles and pores.

The ceramic processing means, such as mixing conditions and milling conditions, that are sufficient to obtain the precursor described above, and the precursor with the characteristic particle size distribution as described above, will be known to the person skilled within the art of ceramic processing.

The order of the ceramic processing means may influence the composite microstructure.

In a further embodiment of the invention, one or more ceramic processing means in step (b) is applied to the metal powder prior to the stabilised zirconia powder. In a further embodiment, the metal powder is milled before the stabilised zirconia powder.

### Ni-YSZ Composite Electrode

A composite of Ni-YSZ is conventionally used as fuel electrode in solid oxide cells. The composite is typically manufactured using wet ceramic techniques, where the components of the composite (i.e. non-reduced NiO and YSZ) is first mixed by mixing suspensions of the powders of NiO and YSZ. The mixing is typically carried out by using ball milling of the oxide powders in a solvent with various additives. The particle size distribution of the suspension (i.e. the composite precursor) is typically evaluated by laser diffraction.

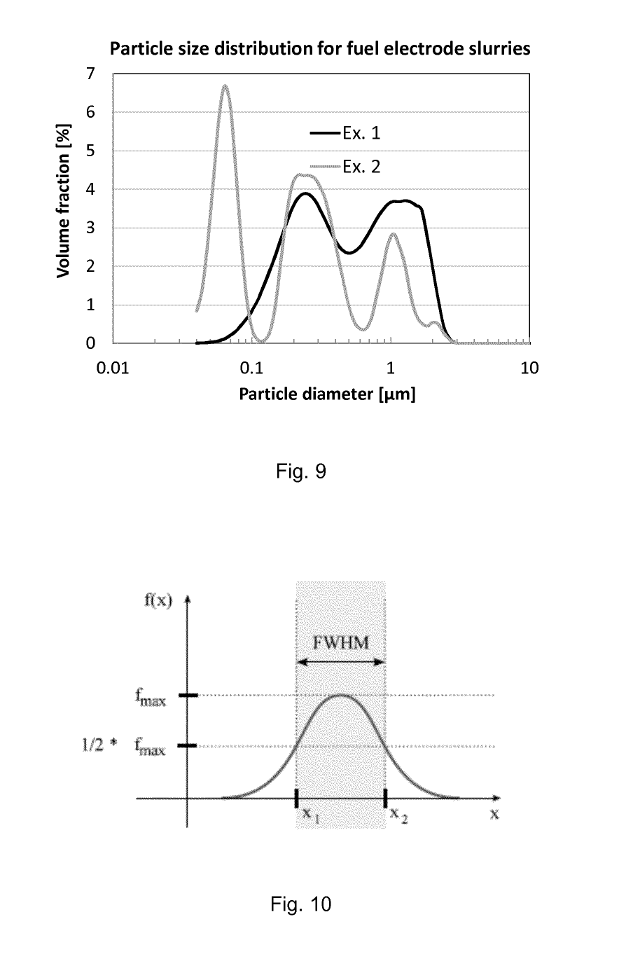

The precursor characteristic particle size distributions obtained by laser diffraction of the NiO-YSZ suspensions from Examples 1 and 2 are shown in FIG. 9, where Example 1 shows a conventional composite precursor, and Example 2 shows an embodiment of the current invention.

In contrast to the convention precursor particle size distribution, the precursor of the current invention shows a trimodal distribution, or a distribution with three or more peaks, and generally smaller precursor characteristic particle diameters (d₁₀: 0.05 μm; d₅₀: 0.2 μm; d₉₀: 1 μm).

The different precursor size distribution of the current invention was obtained by separately stabilizing and milling the NiO particles to an adequate size prior to the dispersing and milling of the YSZ powder.

Furthermore, the precursor particle size distribution and the dispersion may be obtained by stabilizing the suspension with an electro-steric dispersant to avoid agglomeration during the further preparation.

Other ceramic processing means could be used to obtain the precursor characteristic particle size distribution of Example 2. The optimal particle size could also be obtained by synthesizing the composite either by spray-drying nitrates of respective oxides, followed by a calcination step or by other synthesis methods i.e. hydrothermal syntheses.

To form a Ni-YSZ fuel electrode, the NiO-YSZ precursor suspension is shaped by a wet ceramic technique such as tape casting, where a thin layer of suspension with well-defined thickness is formed. The shaped dried layer is the green body, and the thickness of the dried layer is the green thickness. The NiO-YSZ layer may be joined together with other layers e.g. the YSZ electrolyte layer by lamination or multilayer tape casting. The layer(s) are subsequently consolidated by heat treatment (sintering), in where the fuel electrode is densified during the co-sintering process with i.e electrolyte and support. The co-sintering shrinkage properties of the layers ensure the prober density of the fuel electrode and an oxygen electrode is hereafter applied by e.g. screen printing. The NiO component of the composite is reduced to Ni by exposure to a reducing atmosphere, such as a gas comprising hydrogen after heat treatment of the full cell including the oxygen electrode.

The performance of the Ni-YSZ fuel electrode may be tested in an electrolysis test set-up, using e.g. an alumina test house equipped with proper gas inlet, gas distribution system, electrical contacting to the cell and sealing. The performance of the cell is reflected by the cell voltage and the resistances (Ohmic resistance, Rs, and polarization resistance, Rp) of the cell, and the stability of the cell is reflected by the changes in these. Thus, degradation is seen as increased cell voltage or increased Rs or Rp over time. FIG. 1 shows the stability of the two cells from Examples 1 and 2, where the difference between the two cells is the Ni-YSZ fuel electrode. A higher degradation, or lower stability, is observed for the Ni-YSZ fuel electrode of Example 1.

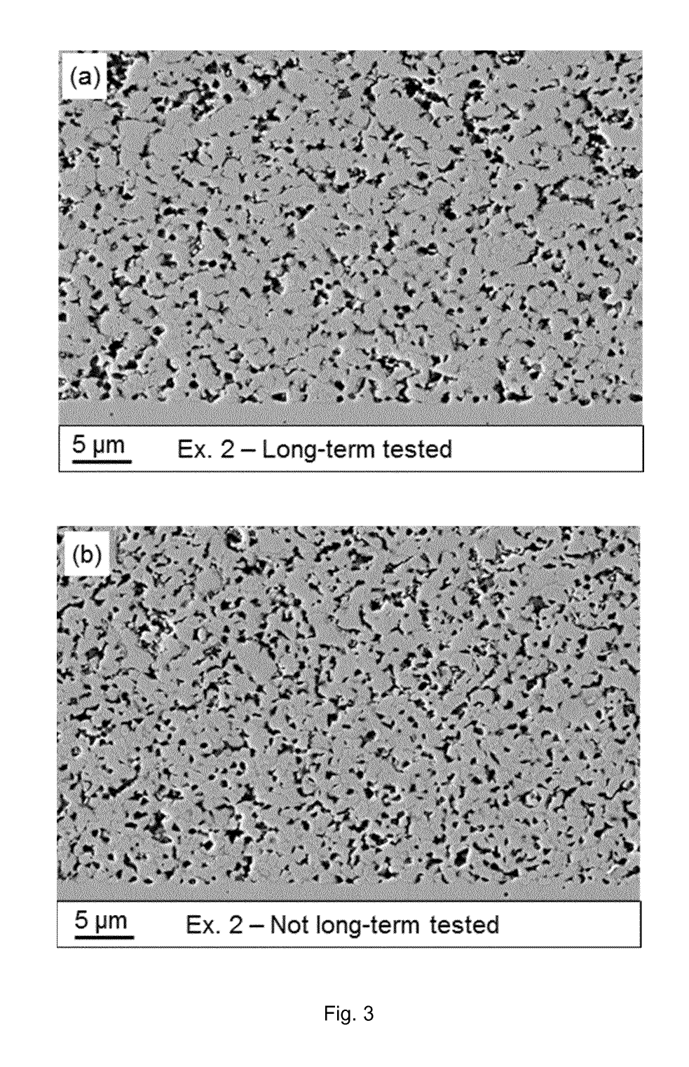

The difference in long-term stability of the Ni-YSZ fuel electrode of Examples 1 and 2 can mainly be ascribed to the Ni-YSZ fuel electrode, and the changes of the microstructure, such as migration and sintering of the Ni phase. This was seen by comparing micrographs before test and after test for the two electrodes as shown in FIGS. 2 and 3. The micrographs are obtained by scanning electron microscopy (SEM), where the black phase is pores, and the grey phase is Ni or YSZ.

FIG. 2 shows the microstructure of the Ni-YSZ fuel electrode of Example 1 before (b), and after (a) the long-term test. Migration of Ni away from the few microns of the electrode closest to the electrolyte is observed long-term electrolysis operation as indicated by the arrows.

FIG. 3 shows the microstructure of the Ni-YSZ fuel electrode of Example 2 before (b), and after (a) the long-term test. No changes or migration of Ni was observed.

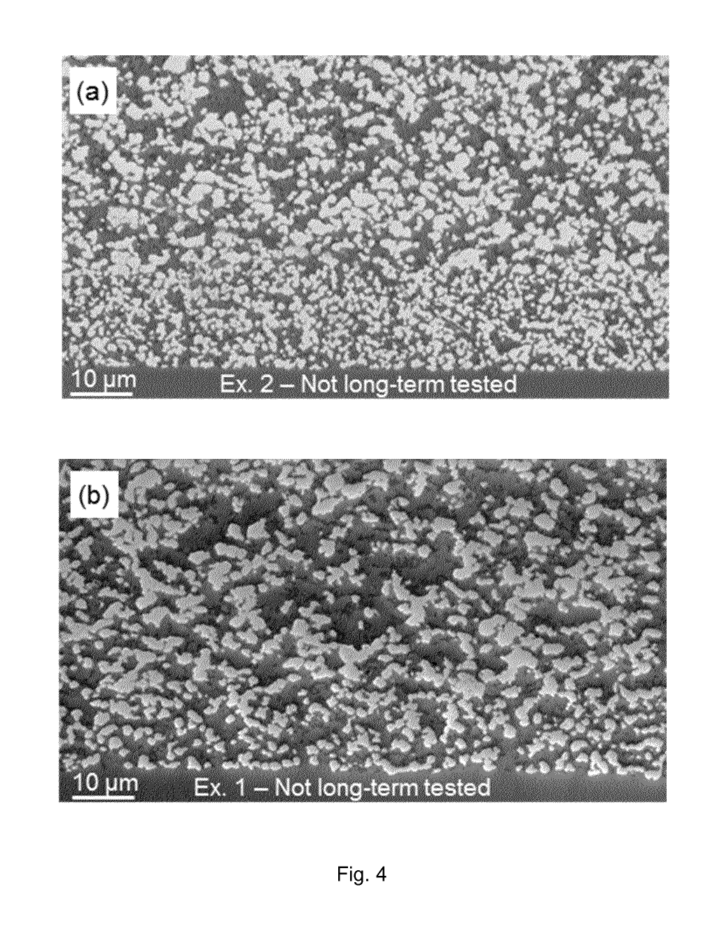

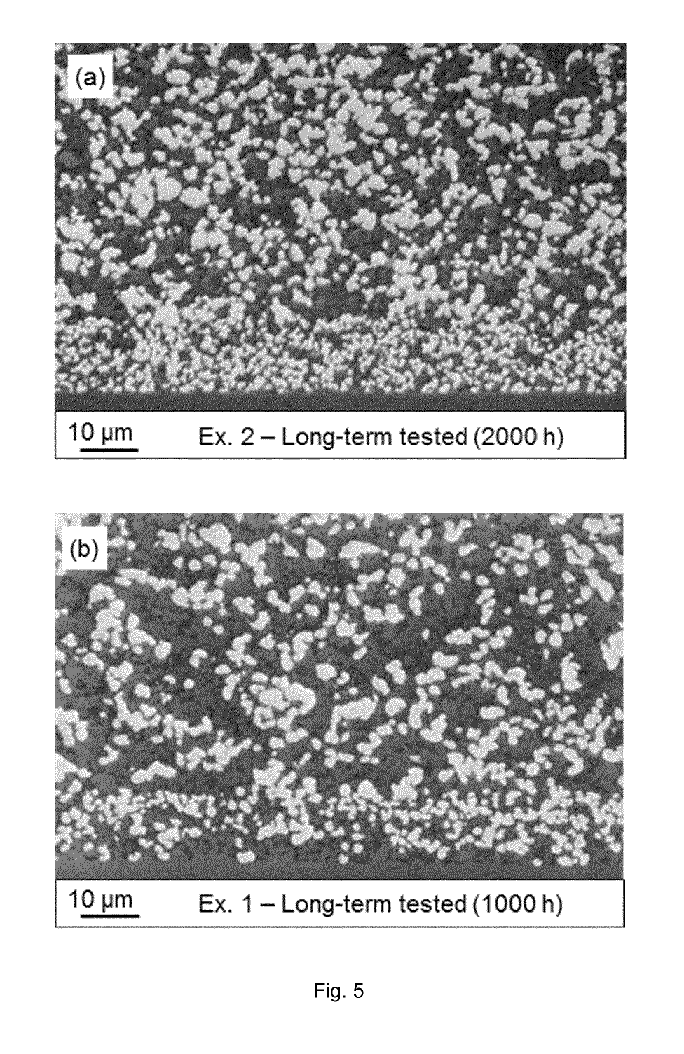

In-lens micrographs of the Ni-YSZ electrodes of Examples 1 and 2 are also shown in FIGS. 4 and 5. In the in-lens micrographs, the Ni and YSZ phase are distinguished by low-voltage (0.8-1 keV acceleration voltage) in-lens SEM, where Ni particles constituting a percolating network will appear as a very bright contrast in the images [4]. This imaging technique provides a qualitative measure for the percolation of the Ni phase and should not be used for analysis of Ni network for electrodes having a Ni volume fraction below ˜22%.

FIG. 4b shows the microstructure of the Ni-YSZ fuel electrode of Example 1 before long-term test, and FIG. 5b shows the structure after long-term test. Significant less bright phase (percolating Ni) was seen at the bottom towards the electrolyte, after long-term test.

FIG. 4a shows the microstructure of the Ni-YSZ fuel electrode of Example 2 before long-term test, and FIG. 5a shows the structure after long-term test. No significant changes in the bright phase was seen at the bottom towards the electrolyte after long-term test.

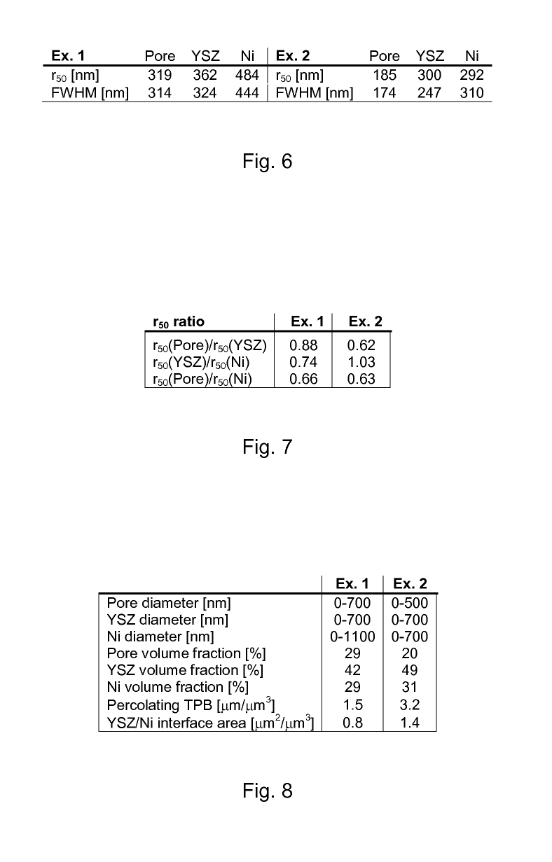

The micrographs of FIGS. 2-5 show the changes in microstructure of the Ni-YSZ electrodes of Examples 1 and 2 qualitatively. The changes may be quantified by image analyses. Three dimensional (3D) image analysis was done on the Ni-YSZ electrodes of Examples 1 and 2, by focused ion beam (FIB) and scanning electron microscopy (SEM), and the results are summarised in FIGS. 6-8.

From FIG. 6 it is seen that in the embodiment of the invention (Example 2), the characteristic median size (r₅₀) of the pore phase is much finer (185 nm radius, 370 nm diameter), compared to the characteristic median pore size of Example 1 (319 nm radius, 638 nm diameter). The ratio between the medians of the phases are shown in FIG. 7.

FIG. 8 shows that in the embodiment of the invention (Example 2), the characteristic diameter of the pores and the Ni phase, is different compared to Example 1. The ranges are more narrow, and the maximum characteristic diameter is 500 nm for pores and 700 nm for Ni in the embodiment of Example 2, whereas they are respectively 700 nm and 1100 nm for Example 1. Furthermore, the embodiment of the invention shows a lower porosity (pore volume fraction in FIG. 8), much higher percolating TPB, and YSZ/Ni interface area (cf. FIG. 8).

The YSZ/Ni interface area and the percolating TPB is a measure of the dispersity of phases in the sintered and reduced structure, as all three phases (pore, electron conducting and oxygen ion conducting) shall be a part of a percolating network in the electrode as well as, a large YSZ/Ni interface area inhibits agglomeration during operation.

### EXAMPLES

The invention is further described by the examples provided below.

### Example 1

### Manufacturing of a Standard Solid Oxide Cell (SOC) with a Ni-YSZ (40:60) Composite

The first step comprises individual tape-casting of four layers on a polymeric support. Layer 1: Fuel electrode support, Layer 2: Fuel electrode, Layer 3: Electrolyte and Layer 4: Barrier layer. The suspensions for tape-casting are manufactured by means of ball milling oxide powders in ethanol, with poly-pyrolidone (PVP), polyvinyl butral (PVB), polyethylene glycol (PEG) and S-2075 as additives.

Layer 1: The suspension comprises yttria stabilized zirconia (YSZ) and 53 vol % NiO, the porosity is about 30% after sintering and reduction. The green thickness is in the range of 350 μm.

Layer 2: The suspension comprises YSZ and 53 vol % NiO. The suspension is the precursor for the Ni-YSZ (40:60) composite. The particle size distribution is shown in FIG. 9 as Ex. 1 (black curve).The suspension has a bi-modal particle size distribution with d₁₀: 0.2 μm; d₅₀: 0.5 μm; d₉₀: 1.7 μm, after high efficiency ball milling with slurry:ball ratio of 1:12.

After tape casting, the green thickness is in the range of 12 μm. The porosity is 29% after sintering and reduction.

Layer 3: The suspension comprises YSZ with green thickness is in the range of 8 μm.

Layer 4: The suspension comprises Ce_{0.9}Gd_{0.1}O_{1.95} (CGO10) with green thickness is in the range of 5 μm.

The second step comprises assembling of the single tape-cast layers by lamination.

In the third step is the laminated half-cell cut into the desired shape by knife punching, resulting in sintered areas of 12×12 cm².

In the fourth step is the half-cell sintered for about 12 h at 1300° C., with a heating ramp of 15° C./h to 600° C. and 60° C./h to 1300° C.

The fifth step comprises deposition of oxygen electrode by screen-printing. Screen-printing ink comprises 1:1 weight ratio mixture of (La_{0.6}Sr_{0.24})ₓCoO_{3-δ (X=1.0-0.99)} and CGO10 in a dowanol based PVB vehicle. The thickness is 30 μm.

The sixth step is sintering of the cell at about 930° C. for 24 h.

The seventh step is reduction of the cell, after sealing, at 850° C. for 2 hour in pure H₂

The structure of the active fuel electrode has after this procedure among others the following characteristics: rₚₒᵣₑ: 0-700 nm; r_{YSZ, Ni}: 0-1100 nm, r_{YSZ}<r_{,Ni}. YSZ/Ni interface area: 0.8 μm²/μm³ and percolating TPB: 1.5 μm/μm³

The cell was tested in a conventional set-up for 1000 hours under the conditions of 800° C., −1 A/cm², H₂O/H₂:90/10 (inlet), 56% H₂O conversion, and O₂ to the oxygen electrode. The performance as a function of time was measured via recording the cell voltage over time and by recording electrochemical impedance spectra during the galvanostatic electrolysis test. The results are shown in FIG. 1 as Ex. 1 (grey curves), where FIG. 1a shows the cell voltage, and FIGS. 1b and 1c respectively the polarisation resistance (Rₚ) and the ohmic resistance (Rₛ).

A significant degradation of the cell performance (increase in cell voltage) was observed. The cell voltage increased almost 250 mV (cf. FIG. 1a), and the degradation was seen to be caused mainly by increased polarisation resistance, and to a minor degree increased ohmic resistance (cf. FIGS. 1b-c).

The cause of the degradation was evaluated to be due to the composite of Layer 2, which was investigated by scanning electron microscopy before and after test. SEM micrographs of the composite (Layer 2) before test (i.e. initial structures) are seen in FIG. 2b, where the pores and porosity is the darkest phase, and in FIG. 4b, where the active Ni is discerned as the brighter phase. The pores and Ni particles were seen to be evenly distributed throughout the structure.

The pore and particle sizes (represented as r₅₀), FWHM and other microstructural characteristics of the composite before test, were also evaluated by 3D image analysis obtained by focused ion beam (FIB) and scanning electron microscopy (SEM). Based on FIB-SEM, a 3D construction of the structure were obtained, and thus a size distribution of the particles. The characteristics of the initial microstructure are summarised in FIGS. 6-8 as Ex. 1.

SEM micrographs of the composite (Layer 2) after test are shown in FIG. 2b, where the pores and porosity is the darkest phase, and FIG. 5b, where the active Ni is discerned as the brighter phase. A significant coarsening of the pores was seen in FIG. 2b (indicated by arrows) compared to the initial structure in FIG. 2b, and a significant decrease in active Ni was seen in FIG. 5b compared to the initial structure in FIG. 4b as well as the Ni phase appeared coarser and less finely distributed.

### Example 2

### Manufacturing of SOC with a Stable Ni-YSZ (40:60) Composite Electrode

The first step comprises individual tape-casting of four layers on a polymeric support. Layer 1: Fuel electrode support, Layer 2: Fuel electrode, Layer 3: Electrolyte, Layer 4: Barrier layer. The suspensions for tape-casting are manufactured by means of ball milling oxide powders in ethanol, with poly-pyrrolidone (PVP), polyvinyl butyral (PVB), polyethylene glycol (PEG) and S-2075 as additives.

Layer 1: The suspension comprises yttria stabilized zirconia (YSZ) and 53 vol % NiO, the porosity is about 30% after sintering and reduction. The green thickness is in the range of 350 μm.

Layer 2: The suspension comprises YSZ and 53 vol % NiO. The suspension is the precursor for the Ni-YSZ (40:60) composite. NiO powder is dispersed and milled separately before addition of YSZ powder. The particle size distribution is shown in FIG. 9 as Ex. 2 (grey curve). The suspension has a three modal particle size distribution with d₁₀: 0.05 μm; d₅₀: 0.2 μm; d₉₀: 1 μm, after high efficiency ball milling with slurry:ball ratio of 1:12.

After tape casting of the suspension, the green thickness is in the range of 12 μm. The porosity is 22% after sintering and reduction.

Layer 3: The suspension comprises YSZ with green thickness is in the range of 8 μm.

Layer 4: The suspension comprises CGO10 with green thickness is in the range of 5 μm.

Layer 3 and 4 are manufactured as a multilayer structure by co-cast of the electrolyte, Layer 3 on the top of the barrier layer, Layer 4.

The second step comprises assembling of the single tape-cast layers and the co-cast layer 3 and 4 by lamination.

In the third step is the laminated half-cell cut into the desired shape by knife punching, resulting in sintered areas of 12×12 cm².

In the fourth step is the half-cell sintered for about 12 h at 1300° C., with a heating ramp of 15° C./h to 600° C. and 60° C./h to 1300° C.

The fifth step comprises deposition of oxygen electrode by screen-printing. Screen-printing ink comprises 1:1 weight ratio mixture of (La_{0.6}Sr_{0.4})ₓCoO_{3-δ (X=1.0-0.99)} and CGO10 in a dowanol based PVB vehicle. The thickness is 30 μm

The sixth step is sintering of the cell at about 930° C. for 24 h.

The seventh step is reduction of the cell, after sealing, at 850° C. for 2 hour in pure H₂

The structure of the active fuel electrode has after this procedure among others the following characteristics: rₚₒᵣₑ: 0-700 nm; r_{YSZ,Ni}: 0-300 nm, r_{YSZ}˜r_{,Ni}. YSZ/Ni interface area: 1.4 μm²/μm³ and percolating TPB: 3.2 μm/μm³

The cell was tested in a conventional set-up for 2000 hours under the conditions of 800° C., −1 A/cm², H₂O/H₂:90/10 (inlet), 56% H₂O conversion, and O₂ to the oxygen electrode. The performance as a function of time was measured viavia recording the cell voltage over time and by recording electrochemical impedance spectra during the galvanostatic electrolysis test. The results are shown in FIG. 1 as Ex. 2 (black curves), where FIG. 1a shows the cell voltage, and FIGS. 1b and 1c respectively the polarisation resistance (Rₚ) and the ohmic resistance (Rₛ).

Compared to the standard cell of Example 1, a significant reduced degradation of the cell performance was observed. After 1000 hours of test, the cell voltage increase was ca. 100 mV (cf. FIG. 1a), and the degradation was seen to be caused by mainly increased polarisation resistance during the first 1000 h after which Rp stabilizes, and with a very low contribution from increased ohmic resistance (cf. FIGS. 1b-c).

The improved degradation was evaluated to be due to a more stable microstructure of the composite of Layer 2. The microstructure was investigated by scanning electron microscopy before and after test. SEM micrographs of the composite (Layer 2) before test (i.e. initial structures) are seen in FIG. 3b, where the pores and porosity is the darkest phase, and in FIG. 4a, where the active Ni is discerned as the brighter phase. The pores and Ni particles were seen to be evenly distributed throughout the structure.

The pore and particle sizes (represented as r₅₀), FWHM and other microstructural characteristics of the composite before test, were also evaluated by 3D image analysis obtained by focused ion beam (FIB) and scanning electron microscopy (SEM). Based on FIB-SEM, a 3D construction of the structure were obtained, and thus a size distribution of the particles. The characteristics of the initial microstructure are summarised in FIGS. 6-8 as Ex. 2.

SEM micrographs of the composite (Layer 2) after 2000 hours of test are shown in FIG. 3a and FIG. 5b. No clear coarsening of the pores was seen in FIG. 3a compared to the initial structure in FIG. 3b. Some decrease in active Ni was seen in FIG. 5a compared to the initial structure in FIG. 4a, however the coarsening appeared mainly in the area furthest away from the electrolyte, and despite the doubled time of test (or operation) for the composite in Example 2 compared to Example 1, the decrease in active Ni appeared to be much lower.

### Example 3

### Manufacturing of a SOC with a stable Ni-YSZ (30:70) Composite

Manufactured as example 1, but Layer 2, in the first step comprises YSZ and 42 vol % NiO. The porosity is 17% after sintering and reduction.

The cell is produced similar to the cell in Example 2 until the fifth step where the (La_{07.5}Sr_{0.25})_{0.9}Co_{0.2}Fe_{0.8} O_{3-δ}/CGO10 composite oxygen electrode applied by screen printing.

In the sixed step is the cell sintered at 1050° C. for 12 h.

The seventh step is reduction of the cell, after sealing, at 850° C. for 2 hour in pure H₂

The structure of the active fuel electrode has after this procedure the following characteristics: rₚₒᵣₑ: 0-200 nm; r_{YSZ, Ni}: 0-300 nm and r_{YSZ}˜r_{,Ni}

### Example 4

### Manufacturing of a SOC with a Stable Ni-YSZ (20:80) Composite

Manufactured as example 2, but Layer 2, in the first step comprises YSZ and 30 vol % NiO.

The suspension for layer 2 is manufactured by milling the oxides in a vertical bead mill with a bead diameter of 1 mm. The suspension comprises YSZ and 53 vol % NiO. The suspension has a three modal particle size distribution with d₁₀: 0.05 μm; d₅₀: 0.2 μm; d₉₀: 1 μm, after high efficiency bead milling with slurry:ball ratio of 1:12. The green thickness is in the range of 12 μm. The porosity is 12% after sintering and reduction. The cell is produced by tape casting and lamination, similar to the cell in Example 2 until the fifth step where the (La_{0.75}Sr_{0.25})_{0.9}Co_{0.2}Fe_{0.8} O_{3-δ}/CGO10 oxygen electrode is applied by screen printing.

In the sixed step is the cell sintered at 1050° C. for 10 h.

The seventh step is reduction of the cell, after sealing, at 850° C. for 2 hour in pure H₂

The structure of the active fuel electrode has after this procedure the following characteristics: rₚₒᵣₑ: 0-200 nm; r_{YSZ, Ni}: 0-300 nm and r_{YSZ}>r_{Ni}

### Example 5

### Manufacturing of a SOC with a stable Ni-ScYSZ (40:60) Composite where the Composite Powder is Synthesized by Spray Drying

The first step comprises individual tape-casting of four layers on a polymeric support. Layer 1: Fuel electrode support, Layer 2: Fuel electrode, Layer 3: Electrolyte, Layer 4: Barrier layer and Layer 5: porous oxygen electrode impregnation layer.

The suspensions for tape-casting are manufactured by means of ball milling oxide powders in ethanol, with poly-pyrolidone (PVP), polyvinyl butral (PVB), polyethylene glycol (PEG) and S-2075 as additives.

Layer 1: The suspension comprises Scandia-yttria stabilized zirconia (ScYSZ) and 53 vol % NiO, the porosity is about 30% after sintering and reduction. The green thickness is in the range of 350 μm

Layer 2: The suspension comprises ScYSZ and 53 vol % NiO, prepared from a calcined powder, manufactured by spray drying of equivalent amount of metal nitrates such as Ni(NO₃)6H₂O. The suspension has a three modal particle size distribution with d₁₀: 0.05 μm; d₅₀: 0.2 μm; d₉₀: 0.8 μm, after high efficiency ball milling with slurry:ball ratio of 1:12. The green thickness is in the range of 12 μm. The porosity is 22% after sintering and reduction.

Layer 3: The suspension comprises ScYSZ with green thickness is in the range of 8 μm

Layer 4: The suspension comprises CGO10 with green thickness is in the range of 5 μm

Layer 5: The suspension comprises ScYSZ and 70 vol % pore former such as PMMA and Graphite or combinations hereof. The green thickness 30 μm

Layer 3 and 4 are manufactured as a multilayer structure by co-cast of the electrolyte Layer 3 on the top of the barrier layer, Layer 4

The second step comprises assembling of the single tape-cast layers and the co-cast layer 3 and 4 by lamination.

In the third step is the laminated half-cell cut into the desired shape by knife punching, resulting in sintered areas of 12×12 cm².

In the fourth step is the half-cell sintered for about 12 h at 1270° C., with a heating ramp of 15° C./h to 600° C. and 60° C./h to 1270° C.

The fifth step comprises coating of the porous ScYSZ oxygen electrode impregnation layer from a nitrate solution of ceria and gadolinium nitrate followed by impregnation of the electroactive oxygen electrode (LaₓSr₁₋ₓ)_{z}Co_{y} Fe_{1-y}O_{3-δ(x=0-1, Y=0-1, Z=1-0.95)} with a suitable precursors, such as Metal nitrates. In between every impregnation step is a decomposition and calcination step of the nitrates at 350C. The described infiltration and calcination steps are repeated until a 20 nm layer of CGO and LSCF is obtained. Example three times repetition for CGO and 8 times repetition for the electroactive oxygen electrode.

The sixth step is in-situ sintering of the cell during startup, at about 900° C. for 2 h.

The seventh step is reduction of the cell, at 850° C. in 9% H₂ in N₂ followed by 1 hour in pure H₂

The structure of the active fuel electrode has after this procedure the following characteristics: rₚₒᵣₑ: 0-700 nm; r_{YSZ, Ni}: 0-300 nm and r_{YSZ}˜r_{,Ni}

### Example 6

### Manufacturing of a Ni-YSZ (50:50) Composite for a Stable Solid Oxide Cell

Manufactured as Example 2, except for Layer 1 and Layer 2.

Layer 1: The suspension comprises yttria stabilized zirconia with 20% Al₂O₃ and 53 vol % NiO, the porosity is about 30% after sintering and reduction. The green thickness is in the range of 350 μm

Layer 2: The suspension comprises YSZ and 63 vol % NiO. The suspension has a hexa modal particle size distribution with d₁₀: 0.05 μm; d₅₀: 0.2 μm; d₉₀: 1 μm, after high efficiency ball milling with slurry:ball ratio of 1:12. The green thickness is in the range of 12 μm. The porosity is 26% after sintering and reduction.

The cell is produced similar to the cell in Example 2 until the fifth step where the (La_{0.75}Sr_{0.25})_{0.95} MnO₃ oxygen electrode is applied by screen printing.

In the sixed step is the cell sintered at 1290° C. for 12 h.

The seventh step is reduction of the cell, after sealing, at 1000° C. for 2 hour in pure H₂

The structure of the active fuel electrode has after this procedure the following characteristics: rₚₒᵣₑ: 0-200 nm; r_{YSZ,Ni}: 0-300 nm and r_{YSZ}˜r_{,Ni}

### Example 7

### Manufacturing of a SOC Cell with Ni-YSZ (40:60) Composite Fuel Electrode and Co-Sintered Porous CGO10 Back-Bone for Oxygen Electrode Infiltration

The cell is manufactured as Example 2 step 1 and 2 and further added a fifth layer (backbone for oxygen electrode): the fifth slurry is consisting CGO10, 40 vol % Graphite (4-6 μm) and 40 vol % PMMA (2 μm) and tape-cast so the dry thickness is 30 μm, the fifth layer is laminated on the fourth layer of the cell.

In the third step is the laminated half-cell cut into the desired shape by knife punching, resulting in sintered areas of 12×12 cm².

In the fourth step is the half-cell sintered for about 12h at 1300° C., with a heating ramp of 15° C./h to 600° C. and 60° C./h to 1300° C.

The fifth step comprises infiltration of LSC in the porous oxygen electrode back-bone from respective nitrate salts, followed by a decomposition step of the nitrates at 350° C.

The seventh step is reduction of the cell, after sealing, at 1000° C. for 2 hour in pure H₂

The structure of the active fuel electrode has after this procedure the following characteristics: rₚₒᵣₑ: 0-200 nm; r_{YSZ Ni}: 0-300 nm and r_{YSZ}˜r_{,Ni}

### Example 8

### Manufacturing of a SOC with an Electro Catalyst Infiltrated Stable Ni-YSZ (50:50) Composite

Manufactured as example 6.

In the eighth step is the fuel electrode infiltrated in the stack with CGO10 and Cu₂O from the respective nitrates.

The ninth step is a second reduction of the cell, at 800° C. for 2 hour in pure H₂.

### Example 9

### Manufacturing of SOC with Respectively a Standard Ni-YSZ (50:50) and a Stable Ni-YSZ (50:50) Composite Electrode

The same manufacturing procedures as described in Examples 1 and 2 were applied to produce cells with Ni-YSZ composites with Ni:YSZ ratio of 50:50, and respectively a standard microstructure, and a microstructure according to an embodiment of the invention with a microstructure optimized for stability.

The cells with 50 vol % Ni and 50 vol % YSZ with respectively standard and optimized fuel electrode structure were produced and tested under the same conditions as for the cells for which results are shown in FIG. 1.

The results for the cells with at 50/50 volume ratios of Ni/YSZ are shown in FIG. 12 where the long-term stability for cell voltage (a), polarisation resistance (b) and Ohmic resistance (c) is shown. The data from FIG. 1 are included for comparison, where the data from Example 1 is denoted “Ni/YSZ:40/60 (Stdr.)” in FIG. 12, and the data from Example 2 is denoted “Ni/YSZ:40/60 (Optimized)” in FIG. 12. The two electrolysis cells with fuel electrodes comprising a Ni/YSZ ratio of 50:50 are denoted as: standard composite denoted “Ni/YSZ:50/50 (Stdr.)”, and composite according to an embodiment of the invention denoted “Ni/YSZ:50/50 (Optimized)”.

Compared to the data from FIG. 1, a significant reduced degradation of the cell performance was observed of the cells with 50/50 volume ratios of Ni/YSZ.

Thus, improved stability, or reduced degradation, may be obtained for Ni/YSZ composites with different Ni/YSZ ratios, and where further the microstructure is optimized for stability according to an embodiment of the invention.

Items

The invention can be further described by the items listed below.

Item 1

A composite for an electrode, comprising a three-dimensional network of dispersed metal particles, stabilised zirconia particles and pores,

wherein the size of the pores is smaller than the size of the metal particles, and
wherein the size of the metal particles is similar or smaller than the size of the stabilised zirconia particles.

Item 1A

A composite for an electrode, comprising a three-dimensional network of dispersed metal particles, stabilised zirconia particles and pores,

wherein the size of the pores is smaller than the size of the metal particles,
wherein the size of the metal particles is essentially equal to or smaller than the size of the stabilised zirconia particles,
wherein the porosity is below 33, 30, or 29 vol %, more preferably below 26 or 24 vol %, and most preferably below 23, 22, 21, 18, 15, or 13 vol %, and/or wherein the pores are essentially exclusively generated from the volume created by reducing a corresponding metal oxide to the metal particles.

Item 2

The composite according to item 1 or 1A, wherein the characteristic size of the pores is smaller than the characteristic size of the metal particles, and

wherein the characteristic size of the metal particles is similar or smaller than the characteristic size of the stabilised zirconia particles.

Item 3

The composite according any of the preceding items, wherein the porosity is generated by reducing a corresponding oxide of the metal to the metallic form.

Item 4

The composite according to any of the items, wherein the porosity is below 33, 30, or 29 vol %, more preferably below 26 or 24 vol %, and most preferably below 23, 22, 21, 18, 15, or 13 vol %.

Item 5

The composite according to any of the items, wherein the maximum characteristic pore diameter is below 700 nm, more preferably below 650 nm or below 600 nm, and most preferably below 550 nm, such as 500 nm.

Item 6

The composite according to any of the preceding items, wherein the median characteristic pore diameter is between 100-630 nm, more preferably between 200-500 nm, and most preferably between 300-400 nm or 350-400 nm.

Item 7

The composite according to any of the preceding items, wherein the maximum characteristic metal particle diameter is below 1100 nm, more preferably below 900 nm or below 800 nm, and most preferably equal to or below 700 nm.

Item 8

The composite according to any of the preceding items, wherein the median characteristic metal diameter is between 200-900 nm, more preferably between 300-800 nm or 400-700 nm, and most preferably between 500-650 nm or 550-600 nm.

Item 9

The composite according to any of the preceding items, wherein the network of metal particles and stabilised zirconica particles are dispersed such that the interface area between the stabilised zirconia and metal is above 0.8 μm²/μm³, more preferably above 1 or 1.2 μm²/μm³, and most preferably equal to or above 1.4 μm²/μm³.

Item 10

The composite according to any of the preceding items, wherein the network of metal particles, stabilised zirconia particles and pores are dispersed to form a percolating TPB, wherein the percolating TPB has a length above 1.5 μm/μm³, more preferably above 2 or 2.5 μm/μm³, and most preferably equal to or above 3.0 or 3.2 μm/μm³.

Item 10A

The composite according to any of the preceding items, wherein the network of metal particles and stabilised zirconica particles has a volume specific interface area between the stabilised zirconia and metal above 0.8 μm²/μm³, more preferably above 1 or 1.2 μm²/μm³, and most preferably equal to or above 1.4 μm²/μm³, and/or wherein the percolating TPB defined by the network of metal particles, stabilised zirconia particles and pores has a volume specific length above 1.5 μm/μm³, more preferably above 2 or 2.5 μm/μm³, and most preferably equal to or above 3.0 or 3.2 μm/μm³.

Item 11

The composite according to any of the preceding items, wherein the metal is selected from the group consisting of Ni, Cu, Cr, Fe, and any combination thereof.

Item 12

The composite according to any of the preceding items, wherein the corresponding oxide of the metal is selected from the group consisting of NiO, CuO, Cu₂O, CrO₂, Cr₂O₃, FeO, Fe₂O₃, Fe₃O₄, and any combination thereof.

Item 13

The composite according to any of the preceding items, wherein the stabilised zirconia is selected from the group consisting of yttria-stabilised zirconia, scandia-stabilised zirconia, yttria- and scandia co-stabilised zirconia, magnesia-stabilised zirconia, calcia-stabilised zirconia, ceria-stabilised zirconia, or a combination thereof.

Item 14

The composite according to any of the preceding items, wherein the volume fraction of metal of the solid phase is 70, 60, 50, 45, 40, 30, or 20 vol %, most preferably essentially 30 vol %.

Item 15

The composite according to any of the preceding items, wherein the volume ratio between metal and stabilised zirconia is 70:30, 60:40, 50:50, 45:55, 40:60, 30:70, or 20:80, most preferably 40:60.

Item 16

An electrode for an electrochemical cell, comprising the composite according to any of items 1-15.

Item 17

A solid state electrochemical cell, comprising the composite according to any of items 1-15.

Item 18

The solid state electrochemical cell according to item 17, wherein the composite is a fuel electrode.

Item 19

Use of the electrochemical cell according to any of items 17-18 as a solid oxide fuel cell, and/or a solid oxide electrolyser.

Item 20

A composite precursor for an electrode, comprising a three-dimensional network of dispersed particles of a metal oxide and a stabilised zirconia,

wherein the precursor characteristic size is d₁₀ between 0.03-0.07 μm, d₅₀ between 0.08-0.4 μm, d₉₀ between 0.4-1.2 μm, more preferably d₁₀ between 0.04-0.06 μm, d₅₀ between 0.1-0.3 μm, d₉₀ between 0.9-1.1 μm, and most preferably d₁₀=0.05 μm, d₅₀=0.2 μm, and d₉₀=1 μm.

Item 21

The composite precursor according to items 20, wherein the porosity is below 5 vol %, more preferably below 3 vol %, and most preferably below 1 vol %.

Item 22

A method of manufacturing a composite for an electrode, comprising the steps of:
(a) providing a powder of a metal oxide and a stabilised zirconia,
(b) applying ceramic processing means such as mixing and milling to the powders,
   whereby the precursor according to any of items 20-21 is obtained,
(c) exposing the precursor to sintering in oxidising conditions, and
(d) exposing the sintered precursor to a thermal treatment in reducing conditions,
   whereby the metal oxide of the precursor is reduced to metallic form, and thereby forming a composite of dispersed metal particles, stabilised zirconia particles and pores.

Item 22A

A method of manufacturing a composite, comprising the steps of:
(a) providing a powder of a metal oxide and a stabilised zirconia,
(b) applying ceramic processing means such as mixing and milling to the powders, sufficiently to obtain the precursor according to any of items 20-21,
(c) exposing the precursor to sintering in oxidising conditions, and
(d) exposing the sintered precursor to a thermal treatment in reducing conditions,
   whereby the metal oxide of the precursor is reduced to metallic form, and thereby forming a composite of dispersed metal particles, stabilised zirconia particles and pores.

Item 23

The method according to item 22 or 22A, wherein one or more ceramic processing means in step (b) is applied to the metal powder prior to the stabilised zirconia powder.

Item 24

The method according to items 22-23, wherein the metal powder is milled before the stabilised zirconia powder.

Item 25

A composite for an electrode obtained by the method of items 22-24.

Item 25A

The composite for an electrode according to item 16 obtained by the method of items 22-24.

### REFERENCES

[1] U.S. Pat. No. 7,029,777.

[2] Kishimoto et al., Fuel Cells, 13 (2013) 476-486.

[3] Lay-Grindler et al., Journal of Power Sources, 269 (2014) 927-936

[4] K. Thydén, et al., Solid State Ionics, 178 (2008) 1984-1989.

1. A composite for an electrode, comprising a three-dimensional network of dispersed metal particles, stabilised zirconia particles and pores,
wherein the size of the pores is smaller than the size of the metal particles,
wherein the size of the metal particles is essentially equal to or smaller than the size of the stabilised zirconia particles,
wherein the porosity is below 33, 30, or 29 vol %, more preferably below 26 or 24 vol %, and most preferably below 23, 22, 21, 18, 15, or 13 vol %, and/or
wherein the pores are essentially exclusively generated from the volume created by reducing a corresponding metal oxide to the metal particles.

2. The composite according to claim 1, wherein the characteristic size of the pores is smaller than the characteristic size of the metal particles, and
wherein the characteristic size of the metal particles is essentially equal to or smaller than the characteristic size of the stabilised zirconia particles.

3. The composite according to any of the preceding claims, wherein the maximum characteristic pore diameter is below 700 nm, more preferably below 650 nm or below 600 nm, and most preferably below 550 nm, such as 500 nm, and/or
wherein the median characteristic pore diameter is between 100-630 nm, more preferably between 200-500 nm, and most preferably between 300-400 nm or 350-400 nm.

4. The composite according to any of the preceding claims, wherein the maximum characteristic metal particle diameter is below 1100 nm, more preferably below 900 nm or below 800 nm, and most preferably equal to or below 700 nm, and/or
wherein the median characteristic metal diameter is between 200-900 nm, more preferably between 300-800 nm or 400-700 nm, and most preferably between 500-650 nm or 550-600 nm.

5. The composite according to any of the preceding claims, wherein the network of metal particles and stabilised zirconica particles has a volume specific interface area between the stabilised zirconia and metal above 0.8 μm²/μm³, more preferably above 1 or 1.2 μm²/μm³, and most preferably equal to or above 1.4 μm²/μm³, and/or wherein the percolating TPB defined by the network of metal particles, stabilised zirconia particles and pores has a volume specific length above 1.5 μm/μm³, more preferably above 2 or 2.5 μm/μm³, and most preferably equal to or above 3.0 or 3.2 μm/μm³.

6. The composite according to any of the preceding claims, wherein the metal is selected from the group consisting of Ni, Cu, Cr, Fe, and any combination thereof, and/or wherein the corresponding oxide of the metal is selected from the group consisting of NiO, CuO, Cu₂O, CrO₂, Cr₂O₃, FeO, Fe₂O₃, Fe₃O₄, and any combination thereof.

7. The composite according to any of the preceding claims, wherein the stabilised zirconia is selected from the group consisting of yttria-stabilised zirconia, scandia-stabilised zirconia, yttria- and scandia co-stabilised zirconia, magnesia-stabilised zirconia, calcia-stabilised zirconia, ceria-stabilised zirconia, or a combination thereof.

8. The composite according to any of the preceding claims, wherein the volume fraction of metal of the solid phase is 70, 60, 50, 45, 40, 30, or 20 vol %, most preferably essentially 30 vol %, and/or wherein the volume ratio between metal and stabilised zirconia is 70:30, 60:40, 50:50, 45:55, 40:60, 30:70, or 20:80, most preferably 40:60.

9. An electrode for an electrochemical cell, comprising the composite according to any of claims 1-8, and/or a solid state electrochemical cell, comprising the composite according to any of claims 1-8, and wherein optionally the composite is a fuel electrode.

10. A composite precursor for an electrode, comprising a three-dimensional network of dispersed particles of a metal oxide and a stabilised zirconia, wherein the precursor characteristic size is d₁₀ between 0.03-0.07 μm, d₅₀ between 0.08-0.4 μm, d₉₀ between 0.4-1.2 μm, more preferably d₁₀ between 0.04-0.06 μm, d₅₀ between 0.1-0.3 μm, d₉₀ between 0.9-1.1 μm, and most preferably d₁₀=0.05 μm, d₅₀=0.2 μm, and d₉₀=1 μm, and/or wherein the porosity is below 5 vol %, more preferably below 3 vol %, and most preferably below 1 vol %.

11. A method of manufacturing a composite, comprising the steps of:
(a) providing a powder of a metal oxide and a stabilised zirconia,
(b) applying ceramic processing means such as mixing and milling to the powders, sufficiently to obtain the precursor according to claim 10,
(c) exposing the precursor to sintering in oxidising conditions, and
(d) exposing the sintered precursor to a thermal treatment in reducing conditions, whereby the metal oxide of the precursor is reduced to metallic form, and
thereby forming a composite of dispersed metal particles, stabilised zirconia particles and pores.

12. The method according to claim 11, wherein one or more ceramic processing means in step (b) is applied to the metal powder prior to the stabilised zirconia powder, and/or wherein the metal powder is milled before the stabilised zirconia powder.

13. The composite for an electrode according to claim 9 obtained by the method of claims 11-12.
